(19) United States
(12) Patent Application Publication
(10) Pub. No.: US 2025/0081094 A1
(43) Pub. Date: Mar. 6, 2025

(54) SYSTEM AND METHOD FOR DELIVERING DATA OVER CELLULAR AND BACKUP NETWORKS

(71) Applicant: Verizon Patent and Licensing Inc., Basking Ridge, NJ (US)

(72) Inventors: Ye Huang, San Ramon, CA (US); Jodi S. Bogen, Alpharetta, GA (US); Jim B. Ranke, Harriman, UT (US)

(21) Appl. No.: 18/457,036

(22) Filed: Aug. 28, 2023

(51) Int. Cl. H04W 48/18; H04W 8/08; H04W 36/14

(52) U.S. Cl. CPC H04W 48/18; H04W 8/08; H04W 36/144

(57) ABSTRACT

A device may receive a data relay request from an application to deliver data to a User Equipment device (UE); select a network path that includes either a satellite network or a cellular network; and forward the data to the UE over the selected network path.

### BACKGROUND INFORMATION

Cellular communications have continued to proliferate. In some areas where cell towers are sparse, mobile network operators (MNOs) may deploy fixed wireless access (FWA) devices. Equipped with antennas that can reach distant cell towers, each FWA device may act as an intermediary between the cell towers and mobile devices. For more remote areas, MNOs may offer satellite-to-cellar connectivity services. When a satellite-to-cellular service is available, a smart phone may connect to a cellular network via a satellite rather than via a cell tower.

### BRIEF DESCRIPTION OF THE DRAWINGS

FIG. 1 illustrates concepts described herein;

FIG. 2 illustrates an exemplary network environment in which systems and methods described herein may be implemented;

FIG. 3 depicts exemplary Fifth Generation (5G) core network components, according to an implementation;

FIG. 4 illustrates an example path table, according to an implementation;

FIG. 5 depicts exemplary Fourth Generation (4G) core network components, according to an implementation;

FIG. 6 illustrates example subscription messages, between core network components, a satellite network, and an application, according to an implementation;

FIG. 7 illustrates example data relay messages, between core network components, a satellite network, and an application, according to an implementation;

FIG. 8A is a flow diagram of an exemplary process that is associated with delivering data over either a cellular network or a satellite network, according to an implementation;

FIG. 8B is a flow diagram of an exemplary process that is associated with selecting either a cellular network or a satellite network for forwarding data, according to an implementation;

FIG. 9 depicts example messages that are exchanged between a User Equipment device (UE), components of a cellular network, a satellite network, and an application for delivering data over either the cellular network or the satellite network, according to an implementation; and

FIG. 10 depicts exemplary functional components of a network device according to an implementation.

### DETAILED DESCRIPTION OF EXAMPLE EMBODIMENTS

The following detailed description refers to the accompanying drawings. The same reference numbers in different drawings may identify the same or similar elements.

Systems and methods described herein relate to delivering data over a cellular network and a backup network. Typical customers of communication services prefer to rely on cellular networks for their primary connectivity for event reporting and alarms. Their preference stems from their need for real-time control, low latency, and high bandwidth. However, for many mission-critical applications, a single-network cellular connectivity may not be sufficient. For example, Internet-of-Things (IoT) devices for monitoring or controlling industrial systems (e.g., oil pipelines, gas pipelines, power grids, etc.) may require a backup communication path in case their primary cellular network fails to provide connectivity. The failure may be due to various reasons, such as a loss of coverage, changes in radio frequency (RF) conditions (e.g., RF interference), changes in weather conditions, natural disasters, etc. With a backup path still intact, the pipelines and power grids and/or other systems may continue to operate. More generally, such a backup path may maintain the connectivity between communication end-devices or networks until the primary network is fully restored.

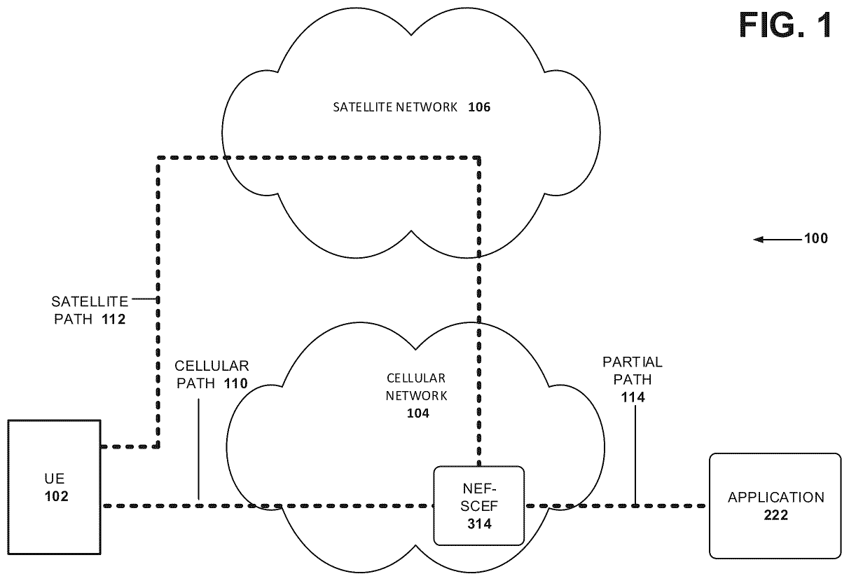

FIG. 1 illustrates concepts described herein. As shown, communication environment 100 includes a User Equipment device (UE) 102 (e.g., IoT sensor or control device), a cellular network 104, a satellite network 106, and a remote application 222. UE 102 may communicate with application 222 over one of two communication paths: a first path which comprises a cellular path 110 that extends from UE 102 to a network component shown as Network Exposure Function (NEF)-Service Capability Exposure Function (SCEF) 314 (described in detail below) within network 104, and a partial path 114 that extends from NEF-SCEF 314 to application 222; and a second path which comprises a satellite path 112 that extends from UE 102 to NEF-SCEF 314 over satellite network 106, and partial path 114. It is assumed that the probability of failure for cellular path 110 is independent of the probability of failure for satellite path 112; and the probability of concurrent failures for paths 110 and 112 is much smaller than the probability of failure for path 110 or the probability of failure for path 112. In addition, partial path 114 is much less likely to fail than either path 110 or 112, as path 114 includes built-in redundancy mechanisms (e.g., backup backhaul links). In FIG. 1, if either cellular path 110 or satellite path 112 fails, UE 102 and application 222 may continue to communicate over the intact communication path.

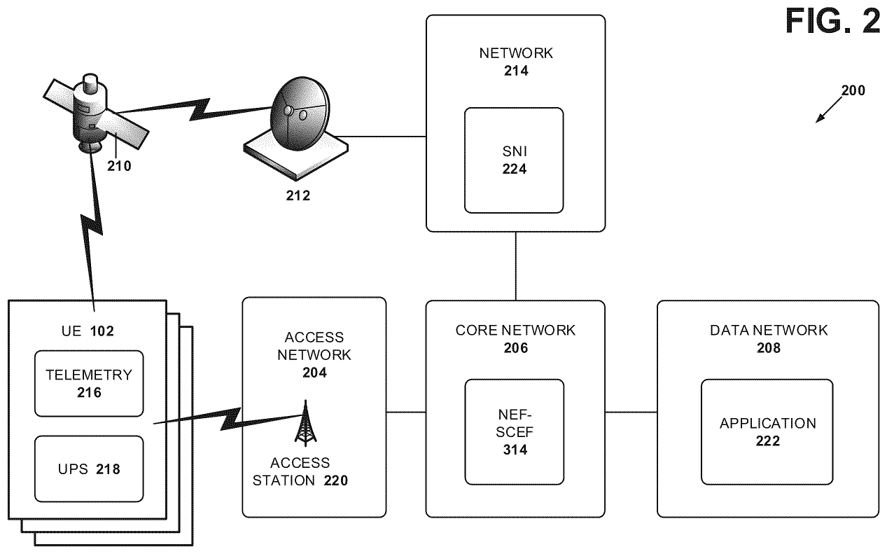

FIG. 2 illustrates an exemplary network environment 200 in which systems and methods described herein may be implemented. As shown, network environment 200 may include one or more of UE 102 (collectively referred to as UEs 102 and generically as UE 102), access network 204, core network 206, one or more of data network 208 (collectively referred to as data networks 208 or generically as data network 208), a satellite 210, a ground station 212, and a network 214. Although not shown in FIG. 2, access network 204, core network 206, and one or more data networks 208 may be part of cellular network 104; and satellite 210, ground station 212, and network 214 may be included in satellite network 106.

UEs 102 may include wireless communication devices capable of 4G (e.g., Long-Term Evolution (LTE)) communication, 5G New Radio (NR) communication, and/or another type of communication. Examples of UE 102 include: an IoT device (e.g., sensor, a controller, an autonomous vehicle, etc.; a wireless Machine-Type-Communication (MTC) device that communicates with other devices over a machine-to-machine (M2M) interface, such as LTE-M or Category M1 (CAT-M1) devices and Narrow Band (NB)-IoT devices; a Fixed Wireless Access (FWA) device; a Customer Premises Equipment (CPE) device with 4G and 5G capabilities; a smart phone; a tablet device; a wearable computer device (e.g., a smart watch); a global positioning system (GPS) device; a laptop computer; a media playing device; and/or a portable gaming system.

As further shown, UE 102 may include telemetry logic 216 and UE path selector (UPS) 218. Telemetry logic 216 may obtain communication-related telemetry information pertaining to cellular network 104 and/or satellite network 106. For example, telemetry logic 216 may obtain RF signal strengths associated with satellite 210 or an access station 220 on access network 204, bandwidths, latencies, etc. UPS 218 may select either satellite 210 (for transmitting signals/data via satellite network 106) or access station 220 (for transmitting signals/data via cellular network 104) to application 222 or another endpoint based on the telemetry information.

Access network 204 may allow UE 102 to access core network 206. To do so, access network 204 may establish and maintain, with participation from UE 102, an over-the-air channel with UE 102; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUS), and wireless stations, one of which is illustrated in FIG. 2 as access station 220 for establishing and maintaining over-the-air channels with UEs 102. In some implementations, access station 220 may include a 4G, 5G, or another type of base station (e.g., gNB, eNB, etc.) that includes one or more RF transceivers. In some implementations, access station 220 may be part of an evolved Universal Mobile Telecommunications Service (UMTS) Terrestrial Radio Access Network (eUTRAN).

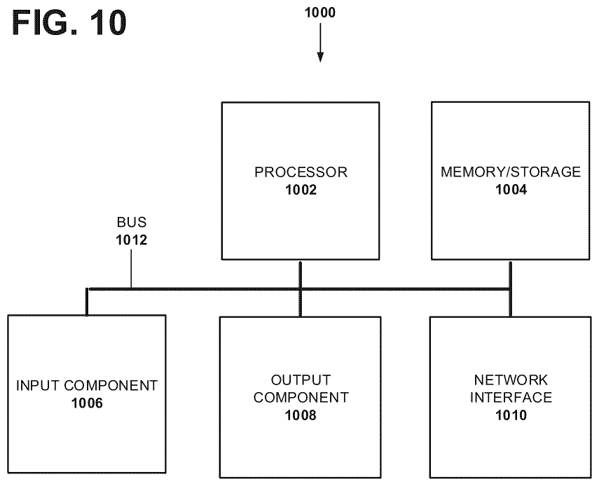

Core network 206 may manage communication sessions of subscribers connecting to core network 206 via access network 204. For example, core network 206 may establish an Internet Protocol (IP) connection between UEs 102 and data networks 208. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven serverless architecture interface, and/or another type of SDN component. The common shared physical infrastructure may be implemented using one or more devices 1000 described below with reference to FIG. 10 in a cloud computing center associated with core network 206.

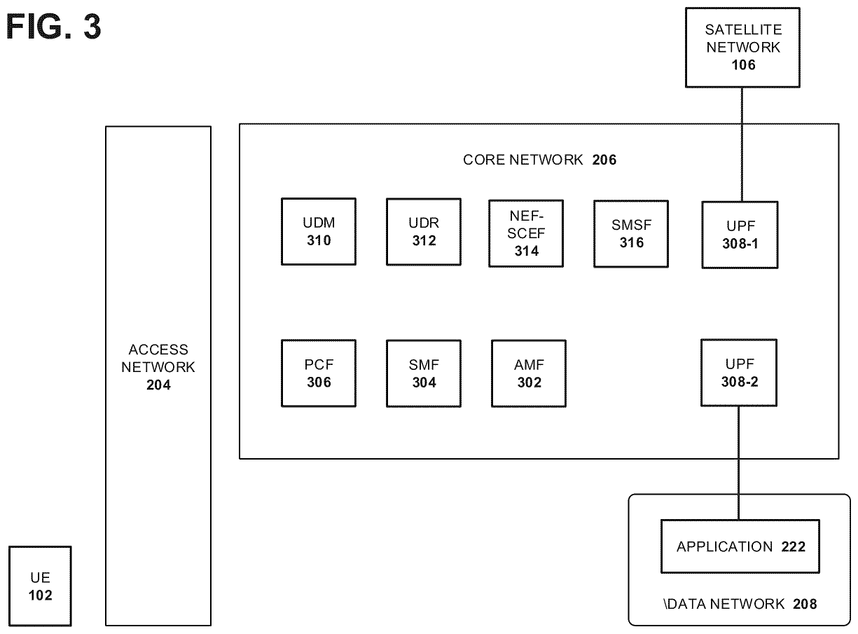

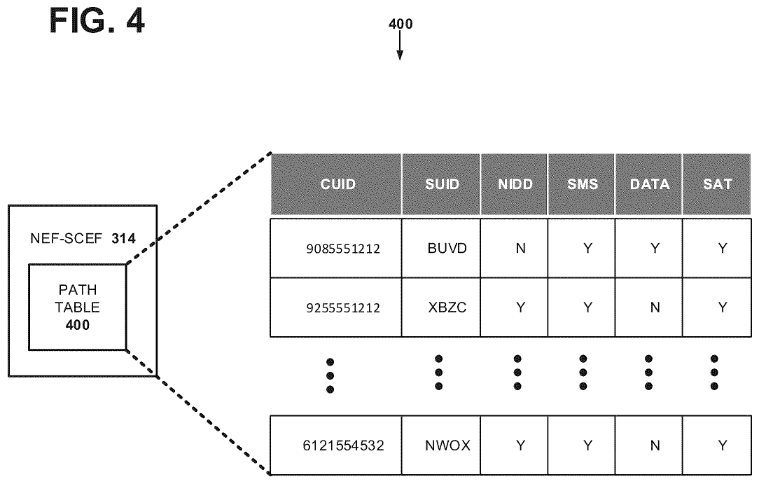

Core network 206 may include 5G core network components, 4G core network components, and/or another type of core network components. Some of 4G core components and 5G core components, one of which is shown in FIG. 2 as NEF-SCEF 314, are described in greater detail below with reference to FIGS. 3 and 4.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may provide services for a program or an application running on UEs 102 and may establish communication sessions with UEs 102 via core network 206.

As further shown, data network 208 may include application 222 that provides various services to UEs 102. To support the backup role of satellite network 106, application 222 may be capable of subscribing to path notification services at NEF-SCEF 314 and receive path notifications from NEF-SCEF 314. When application 222 has IP data to send to UE 102 and has a connection to UE 102, application 222 may forward the data via a user plane function or a gateway. In other situations, if application 222 has data to send to UE 102, application 222 may forward the data to NEF-SCEF 314 via a particular application programming interface (API) call. When application 222 makes an API call to NEF-SCEF 314 to send data to UE 102, depending on information provided by path notifications from NEF-SCEF 314 (e.g., information indicating cellular path 110 is not available) and the configuration of application 222, application 222 may specify, in the API call, whether NEF-SCEF 314 is to send data to UE 102 over path 110, send data over path 112, or select either path 110 or 112 on its own and forward the data to UE 102 over the selected path. Application 222 may receive data from UE 102 via NEF-SCEF 314 over path 114. Depending on the implementation and/or configuration of application 222, application 222 may receive data from UE 102 via another path.

Satellite 210 may receive uplink cellular communication signals from UEs 102, process the signals, and transmit the processed signals to ground station 212. Conversely, satellite 210 may receive uplink cellular communication signals from ground station 212, process the signals, and transmit the processed signals to UEs 102. Ground station 212 may receive signals from satellite 210, process the signals to generate signals for network 214 and provide the processed signals to network 214. Conversely, ground station 212 may receive signals from network 214, process the signals, and transmit the processed signals to satellite 210.

Network 214 may include one or more networks connected to core network 206. For example, network 214 may include a LAN, a WAN, an autonomous system, an optical network, a CDMA network, a GPRS network, an intranet, or a combination of networks. Network 214 may provide connectivity between core network 206 and ground station 212.

As further shown, network 214 may include a satellite network interface (SNI) 224. To support the backup role of satellite network 106, satellite network interface 224 may include logic for determining whether a particular UE 102 is reachable via one or more of satellites 210 and ground stations 212. In addition, satellite network interface 224 may permit network components, such as NEF-SCEF 314, to subscribe with satellite network interface 224 to receive path notifications from satellite network interface 224. For example, when a communication session from UE 102 to network 214 terminates and/or UE 102 becomes unreachable via satellite network 106, satellite network interface 224 may notify NEF-SCEF 314 that is subscribed with satellite network interface 224.

In addition, satellite network interface 224 may be capable of receiving data from application 222 via NEF-SCEF 314. In particular, when satellite network interface 224 receives data, which originated from application 222, from NEF-SCEF 314 via an API call, satellite network interface 224 may forward the data to UE 102 over satellite network 106. Conversely, when satellite network interface 224 receives data, whose ultimate destination is application 222, from UE 102 over satellite network 106, satellite network interface 224 may forward the data to NEF-SCEF 314 over a T8 interface or an IP interface. NEF-SCEF 314 may then relay the data to application 222.

For clarity, FIG. 2 does not show all components that may be included in network environment 200 (e.g., routers, bridges, wireless access points, additional networks, additional access stations 220, data centers, portals, etc.). Depending on the implementation, network environment 200 may include additional, fewer, different, or a different arrangement of components than those illustrated in FIG. 2.

FIG. 3 depicts exemplary 5G core network components 302-314 in core network 206 according to an implementation. As shown, core network 206 may include Access and Mobility Management Function (AMF) 302, a Session Management Function (SMF) 304, a Policy Control Function (PCF) 306, a User Plane Function (UPF) 308-1 and UPF 308-2 (collectively referred to as UPFs 308 and generically as UPF 308), a Unified Data Management (UDM) 310, a Unified Data Repository (UDR) 312, an NEF-SCEF 314, and a Short Message Service Function (SMSF) 316. Although core network 206 is depicted as including network components 302-314 in FIG. 3, in practice, core network 206 may include additional, fewer, and/or different 5G core network components than those illustrated in FIG. 3. For example, core network 206 may further include an Authentication Server Function (AUSF), a Charging Function (CHE), a Network Slice Selection Function (NSSF), a Network Data Analytics Function (NWDAF) and/or other network functions.

AMF 302 may perform registration management, connection management, reachability management, mobility management, lawful intercepts, Short Message Service (SMS) transport between UE 102 and SMSF 316, session management messages transport between UE 102 and SMF 304, access authentication and authorization, location services management, functionality to support non-Third Generation Partnership Program (3GPP) access networks, and/or other types of management processes.

To support the backup role of satellite network 106, AMF 302 may permit network functions (NFs), such as NEF-SCEF 314 to subscribe with AMF 302 to receive notifications from AMF 302 when the connection status of a UE 102 with network 104 changes. For example, if NEF-SCEF 314 is subscribed with AMF 302 for the connection/reachability status of a particular UE 102/session, AMF 302 may notify NEF-SCEF 314 when UE 102 is no longer attached to network 104. In addition to rendering notification services, when requested by NEF-SCEF 314, AMF 302 may relay generic data from NEF-SCEF 314 to UE 102.

SMF 304 may perform session establishment, session modification, and/or session release, perform Internet Protocol (IP) address allocation and management, perform Dynamic Host Configuration Protocol (DHCP) functions, perform selection and control of UPFs 308, configure traffic steering at UPFs 308 to guide the traffic to the correct destinations, terminate interfaces toward PCF 306, perform lawful intercepts, charge data collection, support charging interfaces, control and coordinate charging for data collection, terminate session management parts of Non-Access Stratum (NAS) messages, perform downlink data notification, manage roaming functionality, and/or perform other types of control plane processes for managing user plane data.

PCF 306 may support policies to control network behavior, provide policy rules to control plane functions (e.g., to SMF 304), access subscription information relevant to policy decisions, make policy decisions, and/or perform other types of processes associated with policy enforcement. In some implementations, PCF 306 may determine whether satellite network 106 provides backup paths for particular UEs 102 and cause NEF-SCEF 314 to subscribe with satellite network 106 (e.g., with satellite network interface 224 in satellite network 106) to receive path notifications, enable NEF-SCEF 314 to receive subscription requests from application 222 to receive path notifications from NEF-SCEF 314, and/or cause NEF-SCEF 314 to subscribe with AMF 302 to receive path notifications from AMF 302.

UPF 308 may maintain an anchor point for intra/inter-Radio Access Technology (RAT) mobility, maintain an external protocol data unit (PDU) point of interconnect to a particular data network (e.g., data network 208), perform packet routing and forwarding, perform the user plane part of policy rule enforcement, perform packet inspection, perform lawful intercept, perform traffic usage reporting, perform Quality of Service (QoS) handling in the user plane, perform uplink traffic verification, perform transport level packet marking, perform downlink packet buffering, forward an “end marker” to a radio access network (RAN) node (e.g., access station 220), and/or perform other types of user plane processes. As shown, UPF 308-1 may act as a gateway to satellite network 106 and UPF 308-2 may act as a gateway to network 208. Additionally, when requested by NEF-SCEF 314 via an API, UPF 308 may route IP data from NEF-SCEF 314 to UE 102.

UDM 310 may maintain subscription information for UEs 102, manage user subscriptions, generate authentication credentials, handle user identification, perform access authorization based on user subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store the data that it manages in UDR 312. UDR 312 may store subscription data/profiles, policy data, application data, and exposure data. The user subscription data may include information that is associated with the subscribers of network 104. The subscription data may be made available to other NFs via UDM 310. The policy data may include policy rules and parameters associated with the policy rules. The application data may comprise information and/or data collected by applications.

NEF-SCEF 314 may expose network component capabilities and events internal to core network 206 and/or data networks 208 to devices and network functions external to core network 206, including third party network functions. That is, NEF-SCEF 314 may permit a device or a component external to core network 206 to access network functions, programs, or devices in core network 206.

To support the backup role of satellite network 106, NEF-SCEF 314 may implement a path notification service. When a network function or a network component subscribes to the path notification service for a particular path or UE 102, NEF-SCEF 314 may notify the subscribed network function or component when the connection status of the UE 102 or the status of the session changes. For example, if application 222 is subscribed with NEF-SCEF 314 for the path notification service for a particular UE 102, NEF-SCEF 314 may send a notification to application 222 when NEF-SCEF 314 determines that UE 102 is no longer reachable over network 106.

In addition to offering its path notification service to other network functions and components, NEF-SCEF 314 may subscribe to path notification services with AMF 302 and satellite network 106. When making a path notification request, NEF-SCEF 314 may specify UE 102 or a session whose status of which NEF-SCEF 314 is to be notified. For example, NEF-SCEF 314 may subscribe with the path notification service at satellite network 106, to be notified of reachability of a particular UE 102 via satellite network 106.

In addition to its capabilities to subscribe to path notification services, NEF-SCEF 314 may route data received from either satellite network 106 and/or a network component/function in network 104 to application 222. When NEF-SCEF 314 is to route data in the reverse direction (e.g., when NEF-SCEF 314 receives a request to forward data from application 222), NEF-SCEF 314 may either route the data to UE 102 in accordance with an explicit instruction from application 222 regarding the path or select the path on its own based on past path notifications that NEF-SCEF 314 has received from other network components. For example, NEF-SCEF 314 may send the data from application 222 over satellite network 106 if NEF-SCEF 314 has received a path notification, from AMF 302, which indicates that the UE 102 is not reachable via network 104.

For NEF-SCEF 314 to select either network 104 or satellite network 106 as a path to deliver data to UE 102, NEF-SCEF 314 may maintain and use a path table that summarizes information provided by path notifications from AMF 302, satellite network 106, and/or other network components. FIG. 4 illustrates an example path table 400, according to an implementation. In table 400, each row may correspond to path information for a particular UE 102 and application 222. As shown, table 400 may include a (Cellular network Unique Identifier (CUID) field and a Satellite network Unique Identifier (SUID) field, a Non-IP Data Delivery (NIDD) field, Short Messaging Service (SMS) field, generic data (DATA) field, and a satellite (SAT) field. In other implementations, table 400 may include additional, fewer, or different fields than those illustrated in FIG. 4. For example, in one implementation, table 400 may include a field for storing an ID of application 222.

The CUID field may store an ID of UE 102 (UE ID) that is unique within network 104. Examples of UE ID include a Mobile Subscriber Integrated Services Digital Network (MSISDN) number, an International Mobile Subscriber Identity (IMSI), a Subscription Permanent Identifier (SUPI), and a Subscription Concealed Identifier (SUCI). The SUID field may store a UE ID that is unique within satellite network 106. The NIDD field, the SMS field, and the DATA field may store indications of whether means for delivering, respectively, non-IP data, a SMS message, and generic data is available in network 104. The SAT field may store an indication of whether a path for delivering data to UE 102 over satellite network 106 is available for use.

SMSF 316 may deliver short messages between UEs 102 and other network components. To support the backup role of satellite network 106, SMSF 316 may be capable of receiving data relay requests from NEF-SCEF 314 and relay the data to UE 102.

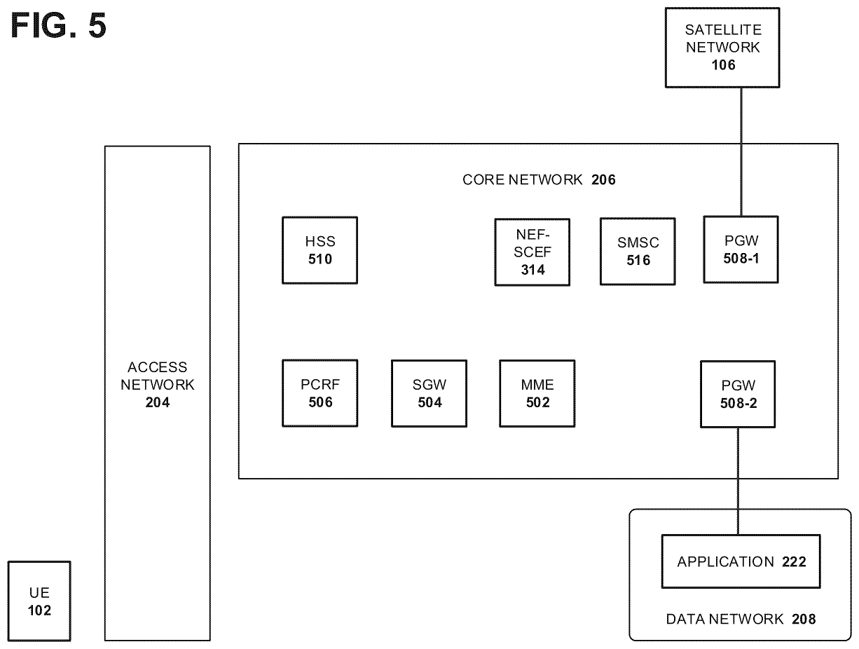

FIG. 5 depicts exemplary 4G core network components 314 and 502-510 in core network 206 according to an implementation. As shown, core network 206 may include: NEF-SCEF 314, a Mobility Management Entity (MME) 502, a Serving Gateway (SGW 504), a Policy and Charging Rules Function (PCRF) 506, a Packet Data Network Gateways (PGW) 508-1 and 508-2 (collectively PGWs 508 and generically PGW 508), a Home Subscriber Server (HSS) 510, and a Short Message Service Center (SMSC) 516. The functionalities of MME 502, SGW 504, PCRF 506, PGW 508, HSS 510, and SMSC 516 roughly correspond to or are similar to the functionalities of AMF 302, SMF 304, PCF 306, UPF 308, UDM/UDR 310/312, and SMSF 316. Depending on the implementation, core network 206 may further include additional, fewer, or different 4G core network components than those illustrated in FIG. 5.

MME 502 may implement control plane processing for core network 206. For example, MME 502 may manage the mobility of UE 102, implement tracking and paging procedures for UE 102, activate and deactivate bearers for UE 102, authenticate a user of UE 102, and/or interface with non-LTE radio access networks. A bearer may represent a logical channel with particular QOS requirements. MME 502 may also select a particular SGW 504 for a particular UE 102.

For supporting the backup role of satellite network 106, MME 502 may operate similarly as AMF 302. For example, MME 502 may permit NFs, such as NEF-SCEF 314, to subscribe with MME 502 to receive path notifications from MME 502 when a connection status of a particular UE 102 with respect to network 104 changes. For example, if NEF-SCEF 314 is subscribed with MME 502 for the connection/reachability status of a particular UE 102, MME 502 may notify SCEF 314 when UE 102 is no longer attached to network 104.

SGW 504 may provide an access point to and from UE 102, may handle forwarding of data packets for UE 102, and may act as a local anchor point during handover procedures between different access stations 210 (e.g., eNBs). A particular UE 102, while connected to a single SGW 504, may connect to multiple PGWs 308, one for each data network 208 with which UE 102 communicates,

PCRF 506 may implement policy and charging rules functions, such as establishing QoS requirements, setting allowed bandwidth and/or data throughput limits for particular bearers and/or UEs 102, determining charges for a particular service for a UE 102, and/or other types of policy or charging rules. PGW 508 may provide control plane functions and user plane functions associated with communication sessions. PGW 508 may function as a gateway to data networks 208 or other networks (e.g., satellite network 106). A particular PGW 508 may be associated with a particular APN or DNN and UE 102 may connect to the particular data network 208 by connecting to the PGW 508 associated with the particular APN.

HSS 510 may store subscription information associated with UEs 102 and/or information associated with users of UEs 102. For example, HSS 510 may store subscription profiles that include authentication, access, and/or authorization information. Each subscription profile may include information identifying UE 102, authentication and/or authorization information for UE 102, a list of services enabled and/or authorized for 102, device group membership information for UE 102, and/or other types of information associated with UE 102. SMSAC 416 may transport SMS messages between different components of network, such as 4G core network components and UEs 102.

NEF-SCEF 314 may interact with 4G core components 502-510 in a manner similar to that for components 302-312. For example, NEF-SCEF 314 may subscribe to MME 502 for a path notification service and/or forward data relay requests to MME 502. MME 502 may relay the data similarly as AMF 302.

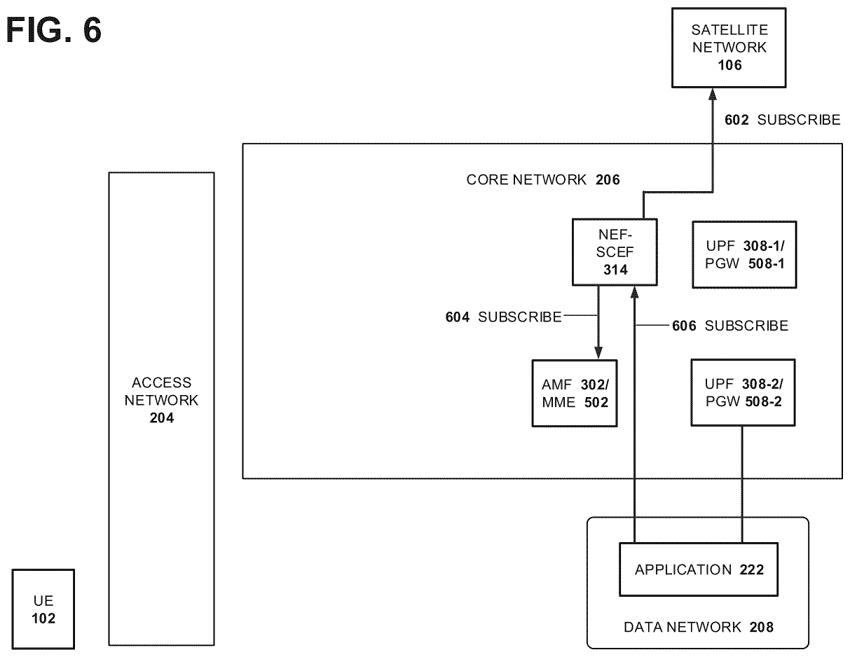

FIG. 6 illustrates example subscription messages, between core network components, a satellite network 106, and application 222, according to an implementation. In particular, the messages relate to subscription requests for path notifications. As shown, NEF-SCEF 314 may send a subscription request 602 to satellite network 106 (e.g., to satellite network interface 224). In one implementation, the subscription request may include an application ID or a network address of application 222. When NEF-SCEF 314 is subscribed to notifications from satellite network 106, satellite network 106 may send, for each UEs 102 attached to satellite network 106 and whose session endpoint includes application 222, path availability (or whether UE 102 is reachable from NEF-SCEF 314 via satellite network 106). The notifications may be sent periodically or when a path status changes.

NEF-SCEF 314 may also send a subscription request 604 to AMF 302/MME 502. In one implementation, the subscription request may include an application ID or a network address of application 222. When NEF-SCEF 314 is subscribed at AMF 302/MME 502, AMF 302/MME 502 may send, for each UE 102 attached to network 104 and whose session endpoint includes application 222, path availability for each of the data types shown in FIG. 4—NIDD, SMS, and generic data (e.g., whether each UE 102 is reachable from NEF-SCEF 314 over network 104 for each data type). AMF 302/MME 502 may send the notifications periodically or when a path status for UE 102 changes.

As further shown, application 222 may send a subscription request 606 to NEF-SCEF 314. In response, NEF-SCEF 314 may forward path status notifications (periodically or when a path status changes) to application 222. Each notification may indicate, for each UE 102 whose session endpoint is application 222, whether the UE 102 is reachable via network 104 or satellite network 106. Based on the notifications, application 222 may store indications of whether each UE 102 is reachable via network 104, satellite network 106, or both network 104 and satellite network 106.

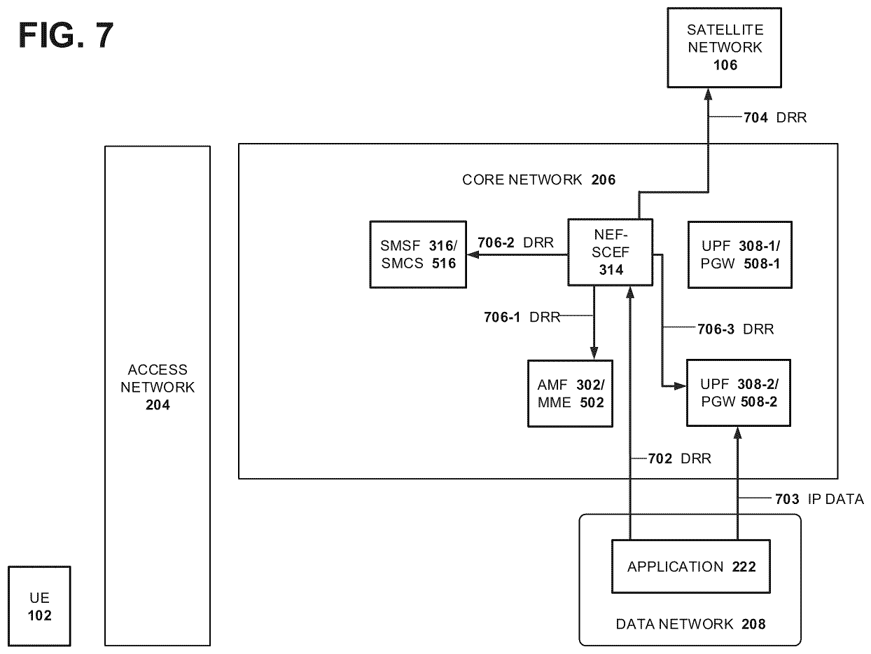

FIG. 7 illustrates example data relay messages or requests, between core network components, satellite network 106, and application 222, according to an implementation. As shown, application 222 may send a data relay request (DRR) 702 to NEF-SCEF 314. The request may include at least a UE ID and the data, Optionally, the request may also include an indication of whether the data is to be delivered via satellite network 106 or network 104 and the data type (e.g., NIDD, SMS, IP data, or generic data). When NEF-SCEF 314 receives DRR 702, NEF-SCEF 314 may take one of several possible sets of actions to forward the data to UE 102, depending on whether DRR 702 specifies a path (path 110 or 112) that NEF-SCEF 314 is to use to forward the data to UE 102. Upon receipt of DRR 702, NEF-SCEF 314 may access table 400, using the UE ID provided in DRR 702, to determine whether UE 102 is reachable via satellite network 106 and/or network 104.

If DRR 702 specifies that the data is to be delivered to UE 102 via satellite network 106 and table 400 indicates that UE 102 is reachable via satellite network 106, NEF-SCEF 314 may look up a SUID in table 400 for the UE 102 and relay the data and the SUID to satellite network 106, via a DRR 704. If DRR 702 specifies that the data is to be delivered to UE 102 via satellite network 106 but UE 102 is not reachable via satellite network 106, NEF-SCEF 314 may send an error message to application 222, indicating that UE 102 is not reachable via the specified path and the data has not been forwarded to UE 102 via satellite network 106.

If DRR 702 specifies that the data is to be delivered to UE 102 via network 104 and table 400 indicates that UE 102 is reachable via network 104, depending on the data type, NEF-SCEF 314 may relay the data and the UE ID to AMF 302/MME 502 via a DRR 706-1 (either SMS message or non-IP data), relay the data and the UE ID to SMSF 316/SMSC 516 via a DRR 706-2 (for SMS message), or relay the data and the UE ID to UPF 308/PGW 508 (e.g., IP data). If DRR 702 specifies that the data is to be delivered to UE 102 via network 104 but UE 102 is not reachable via network 104, NEF-SCEF 314 may send an error message to application 222, indicating that UE 102 is not reachable via the specified path and that the data has not been forwarded to UE 102.

If DRR 702 indicates that NEF-SCEF 314 is to determine whether to forward the data to UE 102 over either satellite network 106 or network 104 and table 400 indicates that UE 102 is reachable via network 104, NEF-SCEF 314 may relay the data and the UE ID to AMF 302/MME 502, SMSF 316/SMSC 516, or UPF 308/PGW 508 via one of DRRs 706—depending on the data type. On the other hand, if table 400 indicates that UE 102 is not reachable via network 104 and UE 102 is reachable via satellite network 106, NEF-SCEF 314 may send the SUID and the data to satellite network 106 via DRR 704. If UE 102 is not reachable by either satellite network 106 or network 104, NEF-SCEF 314 may send an error message to application 222, indicating that UE 102 is not reachable and that the data has not been forwarded to UE 102.

When NEF-SCEF 314 successfully forwards data to UE 102, via satellite network 106 and/or AMF 302/MME 502, NEF-SCEF 314 may send a reply to application 222 indicating that the data has been successfully forwarded.

In some use cases, application 222 may have established a session 710 with UE 102 over UPF 308/PGW 508. If UE 102 is reachable in such a situation, application 222 may send the data (e.g., IP data) to UE 102 over session 710 via UPF 308/PGAW 508, rather than sending the data over a DRR to NEF-SCEF 314.

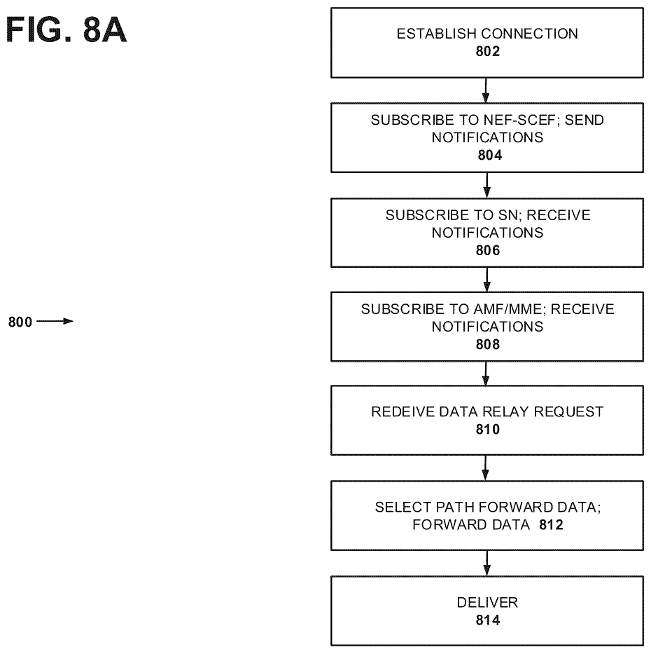

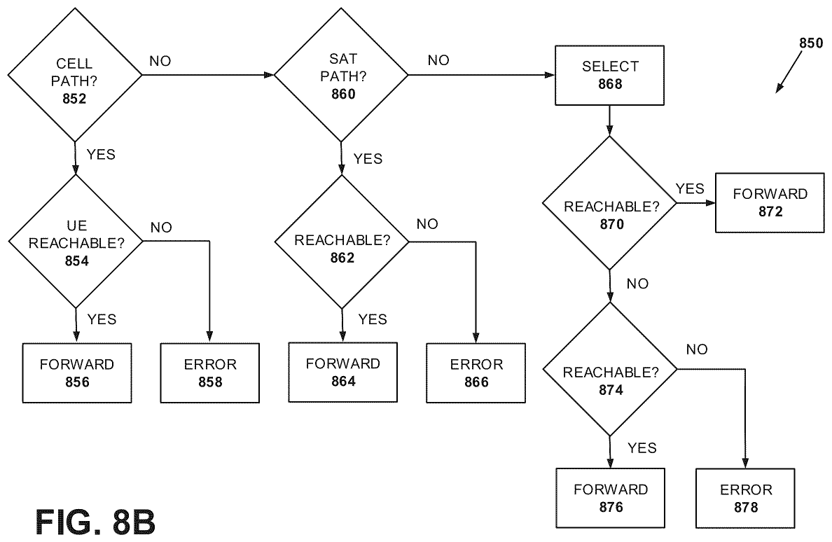

FIG. 8A is a flow diagram of exemplary process 800 which is associated with delivering data over either network 104 or over satellite network 106, according to an implementation. Process 800 may be performed by one or more network components in environment 200, such as UEs 102, NEF-SCEF 314, network 104, satellite network 106, network functions 302-312, and/or network components 502-510. In the example of FIG. 8A, it is assumed that application 222 does not send its data to UE 102 over session 710.

As shown in FIG. 8A, process 800 may include UE 102 establishing one or more connections with application 222 over network 104 and/or satellite network 106 (block 802); and application 222 subscribing to a path notification service at NEF-SCEF 314 (block 804). As a result of application 222 subscribing with NEF-SCEF 314, NEF-SCEF 314 may send path notifications to application 222 (block 804), either periodically or when one or more statuses of the paths change. Each path notification from NEF-SCEF 314 may include, for example, a UE ID of UE 102 in network 104, whether a network path through satellite network 106 is available, whether a path through network 104 is available for different data types (e.g., SMS, NIDD, and generic data).

Process 800 may further include NEF-SCEF 314 subscribing to a path notification service at satellite network 106 (block 806) and receiving path notifications from satellite network 106 (block 806), either periodically or when one or more path statuses change. Each notification from satellite network 106 may include a UE ID which is unique within satellite network 106 (i.e., SUID), an indication of whether UE 102 is reachable via satellite network 106, and/or an ID of an application (e.g., the ID of application 222). In addition, process 800 may include NEF-SCEF 314 subscribing to a notification service at AMF 302/MME 502 (block 808) and receiving path notifications from AMF 302/MME 502 (block 808), either periodically or when one or more path statuses change. Each notification from AMF 302/MME 502 may include a UE ID which is unique within network 104 (i.e., CUID), indications of whether UE 102 is reachable via network 104 for different data types, and an application ID (e.g., the ID of application 222).

Process 800 may further include NEF-SCEF 314 receiving a DRR (data relay request) from application 222 (block 810); and NEF-SCEF 314 selecting a path (i.e., either satellite network 106 or network 104) to deliver the data and forwarding the data over the selected path (block 812). A process for selecting the path and forwarding the data over the selected path is described below in greater detail with reference to FIG. 8B. At block 814, either network 104 or satellite network 106 (whichever one that has been selected by NEF-SCEF 314) may send the data relayed by NEF-SCEF 314 to UE 102.

FIG. 8B is a flow diagram of an exemplary process 850 that is associated with selecting either network 104 or satellite network 106 for forwarding data, according to an implementation. Process 850 may be performed by one or more network components in environment 200, such as UEs 102, NEF-SCEF 314, network 104, satellite network 106, network functions 302-312, and/or network components 502-510. Process 850 may be performed to implement block 812 of FIG. 8A. For process 850, assume that NEF-SCEF 314 has received a DRR from application 222 (see block 810 of FIG. 8A).

As shown in FIG. 8B, process 850 may include NEF-SCEF 314 determining whether the DRR specifies whether the data is to be delivered via cellular network 104 (block 852). If the DRR specifies that it is to be delivered over network 104 (block 852: YES), NEF-SCEF 314 may look up the UE ID in path table 400 to determine whether UE 102 is reachable (block 854). If UE 102 is reachable (block 854: YES), NEF-SCEF 314 may forward the data to AMF 302/MME 502, SMSF 316/SMSC 516, or UPF 308/PGW 508 via a second DRR (block 856). The second DRR may specify the data type. At block 854, if table 400 indicates that the specified UE 102 is not reachable via network 104 (block 854: NO), NEF-SCEF 314 may send an error message to application 222 (block 858), indicating that the data is not forwarded to UE 102 because UE 102 is not reachable via the specified network path.

Returning to block 852, if the DRR from application 222 does not specify NEF-SCEF 314 is to use network 104 to deliver the data (block 852: NO), NEF-SCEF 314 may determine whether the DRR specifies NEF-SCEF 314 is to use satellite network 106 to deliver the data (block 860). If so (block 860: YES), NEF-SCEF 314 may access table 400 to determine whether UE 102 is reachable via satellite network 106 (block 862). If UE 102 is reachable via satellite network 106 (block 862: YES), NEF-SCEF 314 may forward the data to satellite network 106 via a third DRR (864). Otherwise, NEF-SCEF 314 may send an error message to application 222 (block 866), indicating that UE 102 is not reachable via satellite network 106 and that the data has not been forwarded to UE 102.

Returning to block 860, if the DRR from application 222 does not specify that the data is to be delivered to UE 102 via satellite network 106 (block 860: NO), then NEF-SCEF 314 may select a path (either cellular network 104 or satellite network 106) through which NEF-SCEF 314 is to deliver data (block 868). The selection may be based on various factors, such as network latency, congestion level, etc. In one implementation, NEF-SCEF 314 may select network 104 over a satellite network 106 as a default.

Process 850 my further include determining whether UE 102 is reachable over the selected path (block 870). If UE 102 is reachable over the selected path (block 870: YES), NEF-SCEF 314 may forward the data over the selected path, by sending a fourth DRR (block 872). If, however, UE 102 is not reachable via the selected path, NEF-SCEF 314 may determine whether UE 102 is reachable via another, unselected path (block 874).

At block 874, if UE 102 is reachable via the unselected path (block 874: YES), NEF-SCEF 314 may then forward the data over the unselected path, by sending a fifth DRR (block 876). If UE 102 is not reachable even over the unselected path (block 874: NO), NEF-SCEF 314 may send out an error message to application 222, indicating that the data has not been forwarded because UE 102 is not reachable. In process 850, each time NEF-SCEF 314 successfully forwards data (e.g., blocks 856, 864, 872, and 876), NEF-SCEF 314 may send a message to application 222, indicating that the data has been successfully forwarded.

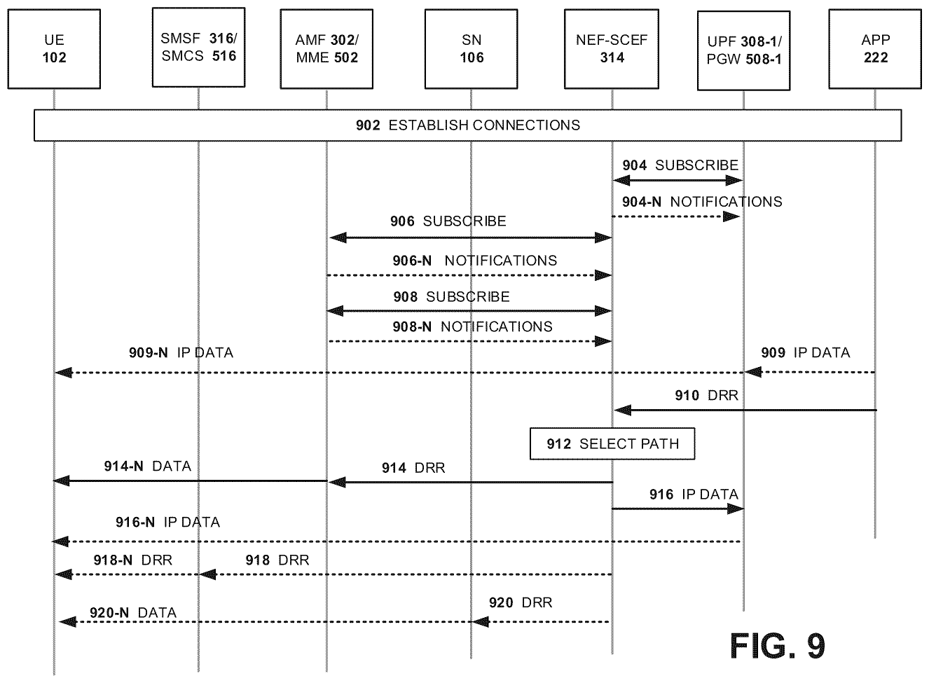

FIG. 9 depicts example messages that are exchanged between UE 102, components of network 104, satellite network 106, and application 222 for delivering data over either network 104 or over satellite network 106, according to an implementation. As shown, UE 102 may establish a connection with application 222 over satellite network (SN) 106 and components of network 104 (e.g., AMF 302/MME 502, SMF 304/SGW 504, UPF 308/PGW 508, SMSF 316/SMSC 516, etc.) (block 902). For FIG. 9, it is assumed that application

Thereafter, application 222 may subscribe to NEF-SCEF 314 (arrow 904); and NEF-SCEF 314 may subscribe to satellite network 106 and AMF 302/MME 502 (arrows 906 and 908). As a result of the subscriptions, application 222 may receive path notifications from NEF-SCEF 314 (dotted arrow 904-N); and NEF-SCEF 314 may receive notifications from satellite network 106 and AMF 302/MME 502 (dotted arrows 906-N and 908-N). NEF-SCEF 314 may create and maintain path table 400 based on notifications 906-N and 908-N.

Later, when application 222 wants to send data (e.g., IP data), UE 102 is reachable, and application 222 has established a session with UE 102, application 222 may forward the data to UE 102 via its connection 909 to UPF 308/PGW 508 and the connection 909-N between UPF 308/PGW 508 and UE 102. If application 222 does not have data that can be sent over the session, application 222 may send DRR 910 to NEF-SCEF 314. When NEF-SCEF 314 receives a DRR 910, NEF-SCEF 314 may select network 104 to deliver data to UE 102 (block 912). NEF-SCEF 314 may then forward a DRR (arrow 914, 916, or 018) to AMF 302/MME 502, SMSF 316/SMCS 516, or UPF 308/PGW 508 which may then forward the data to UE 102 (arrow 914-N, 916-N, or 918-N). At block 912, if NEF-SCEF 314 selected satellite network 106, NEF-SCEF 314 may forward a DRR (dotted arrow 920) to satellite network 106, which in turn may forward the data to UE 102 (dotted arrow 920-N).

FIG. 10 depicts exemplary components of a network device 1000. Network device 1000 may include, correspond to, and/or be included in any of the devices and/or components illustrated in FIGS. 1-7 and 9 (e.g., UE 102, satellite network 106, access network 204, core network 206, data network 208, access station 210, NEF-SCEF 314, AMF 302/MME 502, etc.). In some implementations, network devices 1000 may be part of a hardware network layer on top of which other network layers and network functions (NFs) may be implemented. As shown, network device 1000 may include a processor 1002, memory/storage 1004, input component 1006, output component 1008, network interface 1010, and communication path 1012. In different implementations, network device 1000 may include additional, fewer, different, or different arrangement of components than the ones illustrated in FIG. 10. For example, network device 1000 may include line cards, switch fabrics, modems, etc.

Processor 1002 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1000 and/or executing programs/instructions.

Memory/storage 1004 may include static memory, such as read only memory (ROM), and/or dynamic memory, such as random access memory (RAM), or onboard cache, for storing data and machine-readable instructions (e.g., programs, scripts, etc.). Memory/storage 1004 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1004 may be external to and/or removable from network device 1000. Memory/storage 1004 may include, for example, a Universal Serial Bus (USB) memory stick, a dongle, a hard disk, off-line storage, a Blu-Ray® disk (BD), etc. Memory/storage 1004 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1006 and output component 1008 may provide input and output from/to a user to/from network device 1000. Input/output components 1006 and 1008 may include a display screen, a keyboard, a mouse, a speaker, a microphone, a camera, a DVD reader, USB lines, and/or other types of components for obtaining, from physical events or phenomena, to and/or from signals that pertain to network device 1000.

Network interface 1010 may include a transceiver (e.g., an RF transmitter and a receiver) for network device 1010 to communicate with other devices and/or systems. For example, via network interface 1010, network device 1000 may communicate over a network, such as the Internet, an intranet, cellular, a terrestrial wireless network (e.g., a WLAN, WIFI, WIMAX, etc.), a satellite-based network, optical network, etc. Network interface 1010 may include a modem, an Ethernet interface to a LAN, and/or an interface/connection for connecting network device 1000 to other devices (e.g., a Bluetooth interface).

Communication path or bus 1012 may provide an interface through which components of network device 1000 can communicate with one another.

Network device 1000 may perform the operations described herein in response to processor 1002 executing software instructions stored in a non-transient computer-readable medium, such as memory/storage 1004. The software instructions may be read into memory/storage 1004 from another computer-readable medium or from another device via network interface 1010. The software instructions stored in memory/storage 1004, when executed by processor 1002, may cause processor 1002 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. Accordingly, the specification and drawings are to be regarded in an illustrative rather than restrictive sense.

In the above, while a series of blocks and arrows have been described with regard to the processes illustrated in FIGS. 8A and 8B and the messaging diagram of FIGS. 6, 7 and 9, the order of the blocks and signaling may be modified in other implementations. In addition, non-dependent blocks may represent blocks that can be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor to:
receive a data relay request from an application to deliver data to a User Equipment device (UE);
select a network path that includes either a satellite network or a cellular network; and
forward the data to the UE over the selected network path.

2. The device of claim 1, wherein when the processor selects a network path, the processor is configured to:
select the network path based on path notifications from the satellite network and components of the cellular network.

3. The device of claim 1, wherein the device includes at least one of:
a Network Exposure Function (NEF); or
a Service Capability Exposure Function (SCEF).

4. The device of claim 1, wherein the processor is further configured to:
receive a subscription request from the application to provide the application with path notifications, wherein at least one of the notifications includes:
an indication of whether the UE is reachable over the network path that includes the satellite network; and
an indication of whether the UE is reachable over the network path that includes the cellular network.

5. The device of claim 1, wherein the processor is further configured to:
subscribe with the satellite network to receive path notifications from the satellite network, wherein at least one of the notifications includes:
an indication of whether the UE is reachable via the satellite network.

6. The device of claim 1, wherein the processor is further configured to:
subscribe with either an Access and Mobility Management function (AMF) or a Mobility Management Entity (MME) to receive path notifications from either the AMF or the MME, wherein at least one of the path notifications includes:
a unique identifier of the UE within the cellular network.

7. The device of claim 6, wherein the at least one of the path notifications further includes:
a type of data supported by the network path that includes the cellular network, wherein the type includes at least one of:
Short Messaging Service data;
Internet Protocol (IP) data;
Non-Internet Protocol Data Delivery (NIDD) data; or
generic data.

8. The device of claim 1, wherein the data relay request includes:
an indication that the data is to be forwarded to the UE over the network path that includes the satellite network; or
an indication that the data is to be forwarded to the UE over the network path that includes the cellular network.

9. The device of claim 1, wherein the UE is wirelessly connected to both the cellular network and the satellite network.

10. The device of claim 1, wherein when selecting a network path, the processor is configured to:
use an identifier for the UE to look up first information and second information, wherein when the first and second information indicates that the UE is reachable via both the network path that includes the cellular network and the network path that includes the satellite network, select the network path that includes the cellular network.

11. A method comprising:
receiving, at a device, a data relay request from an application to deliver data to a User Equipment device (UE);
selecting a network path that includes either a satellite network or a cellular network; and
forwarding the data to the UE over the selected network path.

12. The method of claim 11, wherein selecting a network path includes:
selecting the network path based on path notifications from the satellite network and components of the cellular network.

13. The method of claim 11, wherein the device includes at least one of:
a Network Exposure Function (NEF); or
a Service Capability Exposure Function (SCEF).

14. The method of claim 11, further comprising:
receiving a subscription request from the application to provide the application with path notifications, wherein at least one of the notifications includes:
an indication of whether the UE is reachable over the network path that includes the satellite network; and
an indication of whether the UE is reachable over the network path that includes the cellular network.

15. The method of claim 11, further comprising:
subscribing with the satellite network to receive path notifications from the satellite network, wherein at least one of the notifications includes:
an indication of whether the UE is reachable via the satellite network.

16. The method of claim 11, further comprising:
subscribing with either an Access and Mobility Management function (AMF) or a Mobility Management Entity (MME) to receive path notifications from either the AMF or the MME, wherein at least one of the path notifications includes:
a unique identifier of the UE within the cellular network.

17. The method of claim 16, wherein the at least one of the path notifications further includes:
a type of data supported by the network path that includes the cellular network, wherein the type includes at least one of:
Short Messaging Service data;
Internet Protocol (IP) data;
Non-Internet Protocol Data Delivery (NIDD) data; or
generic data.

18. The method of claim 11, wherein the data relay request includes:
an indication that the data is to be forwarded to the UE over the network path that includes the satellite network; or
an indication that the data is to be forwarded to the UE over the network path that includes the cellular network.

19. The method of claim 11, wherein the UE is wirelessly connected to both the cellular network and the satellite network.

20. A non-transitory computer-readable medium comprising computer-executable instructions, which when executed by a processor cause the processor to:
receive a data relay request from an application to deliver data to a User Equipment device (UE);
select a network path that includes either a satellite network or a cellular network; and
forward the data to the UE over the selected network path.
